(19) United States
(12) Patent Application Publication
(10) Pub. No.: US 2002/0187031 A1
(43) Pub. Date: Dec. 12, 2002

(54) Electrically actuated push plate assembly

(76) Inventor: Joseph E. Boyanich, Cheektowaga, NY (US)

Correspondence Address: Stephen B. Salai, Esq., Harter, Secrest & Emery LLP, 1600 Bausch & Lomb Place, Rochester, NY, 14604-2711, US

(21) Appl. No.: 10/108,537

(22) Filed: Mar. 28, 2002

Related U.S. Application Data
(63) Continuation-in-part of application No. 09/878,049, filed on Jun. 8, 2001.

(51) Int. Cl. B62B 1/00

(52) U.S. Cl. 414/490

(57) ABSTRACT

A detachable push plate assembly for hand trucks is disclosed. A user applies downward pressure on a lever arm causing a push plate to move forward and discharge cargo, or to discharge the hand truck out from underneath cargo from the bottom of the hand truck. The push plate assembly comprises four major components: a one piece integral housing; a push plate; a projection bar connected to the push plate; and a one piece pedal assembly coupled to the projection bar. The assembly also comprises a spring that biases the push plate to a retracted position when not in use, and a wear plate or shim to prevent deterioration of the housing base. Alternatively, the push plate assembly may have an electrically driven gear wheel engaging the projection bar, the limits of travel being defined by a limit switch actuated by stops on the gear wheel.

### CROSS REFERENCE TO RELATED APPLICATION

This Application is a Continuation-in-part of application Ser. No. 09/878,049 “Push Plate Assembly”, filed on Jun. 8, 2001, in the name of Joseph Boyanich.

### FIELD OF THE INVENTION

This invention relates to assemblies that attach to existing pushcarts and that make it easier for a user to discharge cargo from the bottom chisel plate of a pushcart. It relates in particular to electrically actuated assemblies.

### BACKGROUND OF THE INVENTION

Over the years many designs for hand trucks have been created. Some of these have included devices or assemblies incorporated for the purpose of easing the unloading of freight from hand trucks. Some of these assemblies were freestanding contraptions.

A problem with past push plate assemblies was the expense of producing the push plate assembly. The previous assemblies were costly to manufacture and it was difficult to alter the original design of the assemblies without incurring more costs.

### SUMMARY OF THE INVENTION

The present invention is an assembly that may be attached to a variety of different hand trucks to ease the unloading of freight such as a box or carton from the chisel of the hand truck. A user may operate it by applying downward pressure on a lever arm. The push plate is connected to the arm and moves forward so as to discharge cargo from the chisel. Alternatively, a foot pedal may be used in place of the lever. A spring then returns the push plate to a rest position at the rear of the chisel. In yet a further alternative, the lever or foot pedal may be replaced by an electric motor operating a gear operably connected to the push plate.

The advantage of the current invention is that it has a lower production cost, because the housing and pedal assembly are each one-piece. They are each stamped out of a sheet of metal and then molded to a desired shape. The entire push plate assembly comprises four major components: (1) a one piece integral housing, (2) a push plate, (3) a rack connected to the push plate, and (4) a one piece pedal assembly. The invention also includes a spring to return the push plate to a rest position, and a wearplate or shim to prevent deterioration of the housing base. However, neither addition is necessary to operate the assembly. They simply make operation more convenient. With the electrically actuated push plate, the gear has cams that trip a limit switch to define the extremes of travel of the push plate.

### BRIEF DESCRIPTION OF THE DRAWINGS

FIG. 1 is a perspective view of a housing of a push plate assembly for a hand truck;

FIG. 2 is a perspective view of a push plate with a projection bar attached thereto in a first embodiment of the invention;

FIG. 3 is a side view of a pedal assembly in the first embodiment;

FIG. 4 is a perspective view of the housing showing the insertion of the projection bar therein in the first embodiment;

FIG. 5 is a partially cut away side view of the first embodiment of the push plate assembly;

FIG. 6 is a side view of a pedal assembly in the second embodiment;

FIG. 7 is a cross-section viewed along 7-7 of FIG. 6;

FIG. 8 is a perspective view of a portion of the projection bar in the second embodiment, showing also a portion of a cable engaged therewith;

FIG. 9 is a perspective view of a cable bracket affixed to an end of the cable;

FIG. 10 is a partially cut away side view of the second embodiment of the push plate assembly;

FIG. 11 is a rear view of the housing;

FIG. 12 is a rear view of the first embodiment of the push plate assembly;

FIG. 13 is a rear view of the push plate assembly attached to the hand truck;

FIG. 14 is a top view of a portion of the housing and attachment members for securing the housing to the hand truck;

FIG. 15 is a side view of the push plate assembly attached to the hand truck, with the push plate in a retracted position;

FIG. 16 is a side view of the push plate assembly attached to the hand truck, with the push plate in an extended position;

FIG. 17 is a side view of the hand truck with the push plate assembly configured to transport an elongate load;

FIG. 18 is a side view of the hand truck with the push plate assembly configured to transport an oversized load;

FIG. 19 is a top view of a blank for fabricating the housing;

FIG. 20 shows elements of the second embodiment, including an upwardly curved projection bar in the retracted position;

FIG. 21 shows elements of the second embodiment, including the upwardly curved projection bar in the extended position;

FIG. 22 is a rear view of portion of a third embodiment wherein an electrically driven gear wheel engages the projection bar;

FIG. 23 is a partially cut away side view of a portion the third embodiment;

FIG. 24 is a similar view to FIG. 23, showing also a propulsion gear, with the gear wheel in a push position;

FIG. 25 is the view of FIG. 24, showing the gear wheel in a drive position.

### DETAILED DESCRIPTION OF THE INVENTION

Referring to the drawings, all of which are schematic and not necessarily to a consistent scale, the present invention is a push plate assembly 100 for a typical hand truck 110 with spaced struts 112, a bottom chisel 114 and wheels 116. It is essentially directed to a mechanism for moving an upright push plate 120 between retracted position and an extended position. Actuation of the push plate 120 assists in discharging cargo from the hand truck 110.

The push plate 120 is arranged generally parallel with the axis of the wheels 116. Its lower edge is closely spaced to the top face of the load-carrying tongue or chisel 114 of the hand truck 110. This push plate 120 preferably extends sideways to an extent to be in front of the wheels 116. It is essentially a rectangular ⅛″ steel plate, having stamped indentations 122 such as those shown in FIG. 2 which provide enhanced strength. A housing 140 essentially carries a mechanism for projecting the push plate 120. This mechanism has a projection bar 160 and a pedal assembly 180. The housing 140 can be removably secured to the hand truck frame, so as to permit the push plate 120, together with the actuating mechanism of the present invention, to be sold as an accessory for existing hand trucks. In a first embodiment, the projection bar 160 and the pedal assembly 180 engage through a rack-and-pinion mechanism. In a second embodiment, the projection bar 160 and the pedal assembly 180 would be coupled with a length of flexible cable 220.

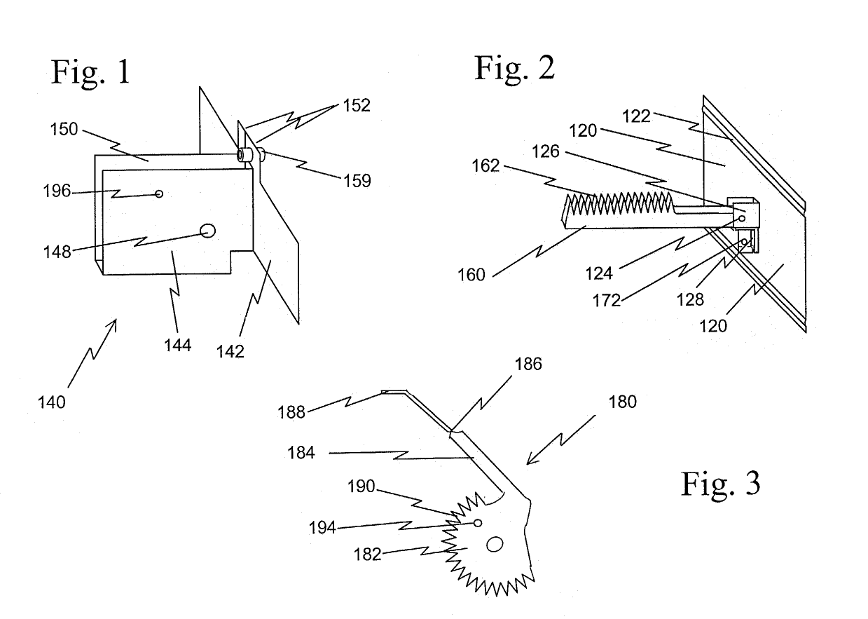

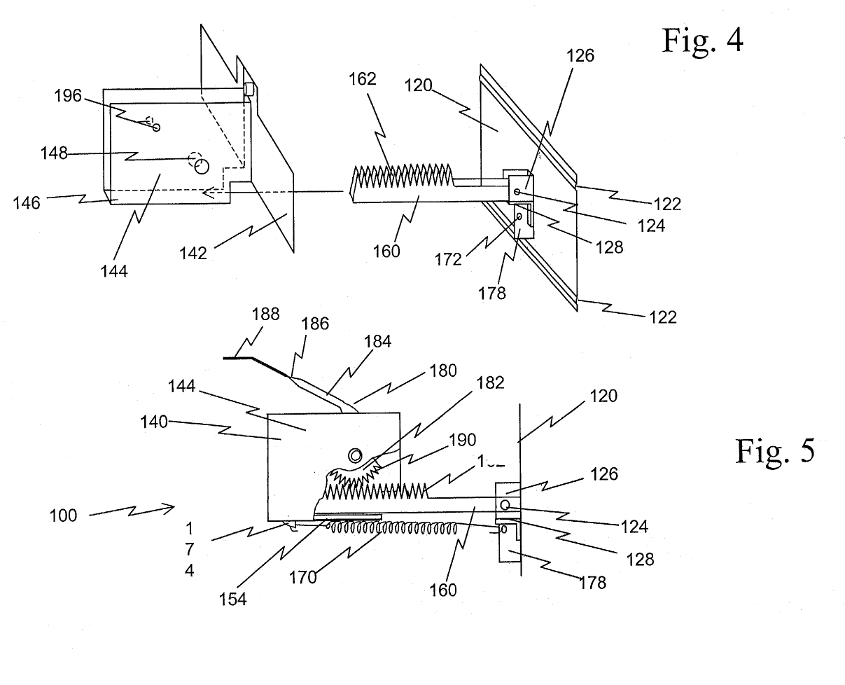

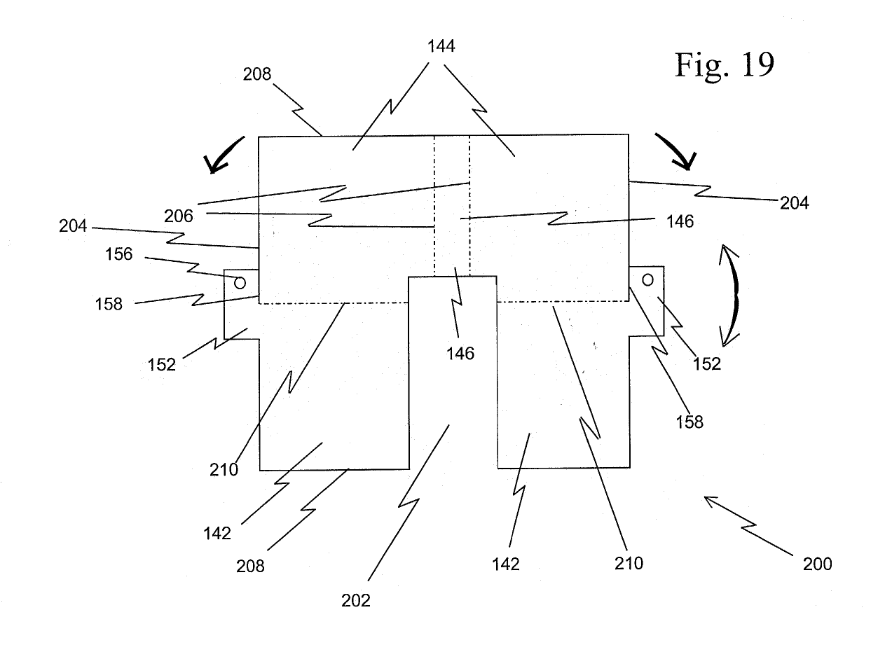

The housing 140 is an integral, solitary piece of material. It is made from a ⅛″ thick stamped steel plate, which is cut to produce a blank 200 illustrated in FIG. 19. The blank 200 is then bent and shaped until it reaches the final configuration shown in FIG. 1.

The housing 140 includes a pair of flanges 142, a pair of sidewalls 144, a bottom 146 and a pair of opposed pedal mounts 148. The sidewalls 144 and the bottom 146 form an open-ended channel 150 for accommodating the projection bar 160 and the pedal assembly 180.

The flanges 142 are sized to contact the struts 112 of the hand truck 110. Note that each flange 142 has an extension 152 having a hole 156.

As shown in FIG. 19, the blank 200 from which the housing 140 is formed is a generally rectangular flat piece of rigid sheet metal having opposed first edges 204 and opposed second edges 208. By rigid is meant that the material holds its shape absent an externally applied force but that it can be bent or shaped by applying a force of the magnitude which is typically applied in sheet metal working. A generally rectangular recess 202 extends from one of the second edges 208 is symmetrically disposed between the first edges 204. Each of a pair of first bend lines 206 defines the boundary between one of the intended sidewalls 144 and the intended bottom 146. They extend from the recess 202 to the non-recessed second edge 208. Each of a pair of second bend lines 210 defines the boundary between a sidewall 144 and a corresponding flange 142. The extensions 152 are joined to the first edges 204, and are partly separated therefrom by slits 158.

To form the housing 140, the blank 200 is bent along the first bend lines 206 until the sidewalls 144 are essentially parallel with each other. As depicted in FIG. 19, the intended sidewalls 144 would be bent towards the viewer. Assuming, only for descriptive purposes that the blank 200 is still flat as depicted in FIG. 19, the sidewalls 144 and flanges 142 would then be bent away from the second bend lines 210 relative to the viewer. Note that in the performance of this operation, each extension 152 remains entirely coplanar with its corresponding flange 142, as is permitted by the existence of the slits 158.

It is understood that while the bottom 146 is shown in the drawings as being essentially flat, it can equally well be curved; instead of forming a right angle along each of the first bend lines 206, the bending operation can instead lead to a smooth curvature between the first bend lines 206, the final shape nevertheless providing that the sidewalls 144 are essentially parallel.

On completion of the bending operation, the extensions 152 overlap so that holes 156 are aligned, allowing the flanges 142 to be secured together with a fastener such as a bolt 159. It is understood, however, that the flanges 142 could equally well be secured by other means such as welding together the extensions 152.

The one-piece pedal assembly 180 is stamped from one sheet of metal. It includes a drive segment 182 and a lever or treadle 184. The lever 184 includes a twist 186, which is added after the pedal assembly 180 is stamped to correctly orient a foot-bearing surface 188 and also to provide structural strength. The assembly 180 could equally well be designed to operate with a hand lever.

The projection bar 160 projects forwardly beyond the housing 140, and is secured by one or more pins 124 to a bracket 126 attached to the rear of the push plate 120 and projecting rearwardly therefrom. This method of attachment provides for convenient replacement of either the push plate 120 or the projection bar, should there be a need to replace only one of these components. If this is of no concern, the projection bar 160 can simply be welded to the bracket 126 or directly to the push plate 120.

When only one pin 124 is used, it is oriented transversely across the width of the projection bar 160, and the push plate may pivot about the pin 124. Beneath the pin 124, a stop 128, which is L-shaped in cross section, is welded or suitably secured to the back of the push plate 120 so that it can contact the bottom of the projection bar 160. As will be seen later, the ability of the push plate 120 to pivot enhances the ability to handle bulky objects. In the remainder of this disclosure, it is understood that a single pin 124 is used and that the push plate 120 is therefore free to pivot.

The projection bar 160 slides over the bottom 146 of the housing 140 between the two flanges 142. Resting on the bottom 146 is a wear plate or shim 154, preferably made of bearing metal. The shim also has two flaps, one at either end, that hold it in place while the projection bar 160 slides back and forth across the top of it. The end flanges are used to secure the shim into place on the housing 140 during movement of the projection bar 160.

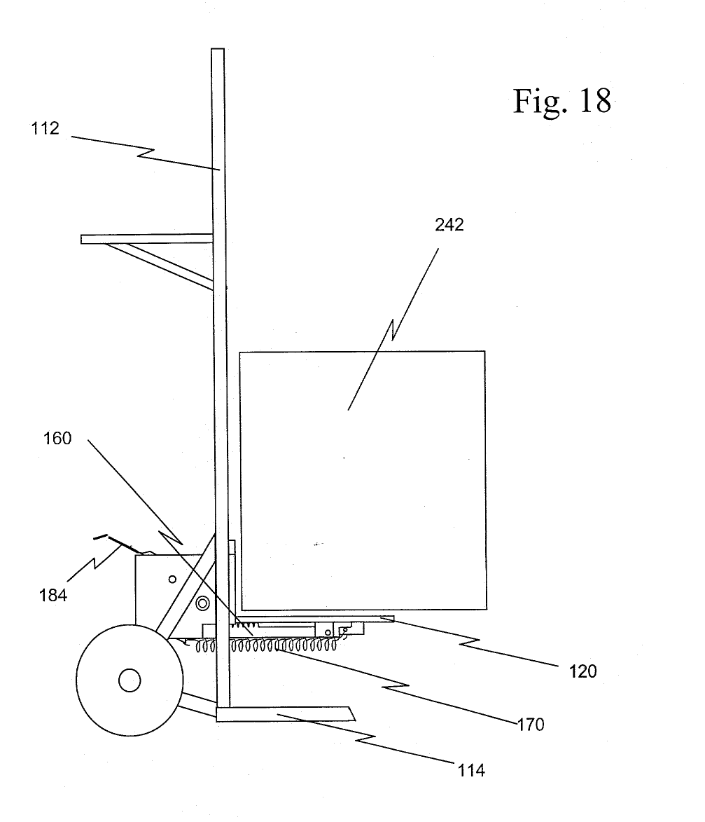

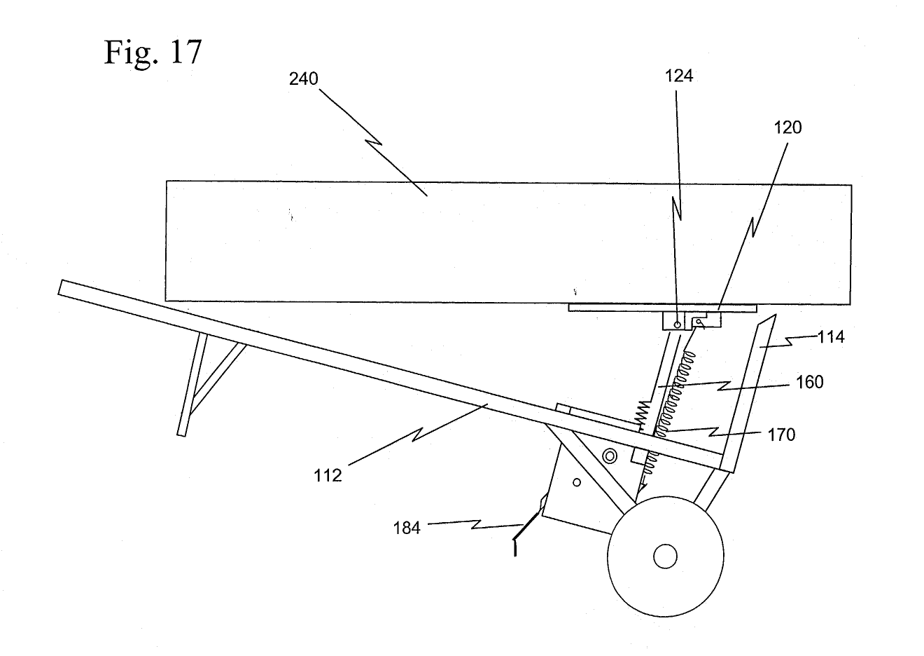

In a rest or retracted position, the stop 128 is removably engaged with the bottom of the projection bar 160 and is normally held in engagement with the projection bar 160 by a helical tension return spring 170. When the push plate 120 pivots about the pin 124, it can do so in only one direction starting from its normal position essentially parallel to the chisel 114 as indicated in FIG. 16, removing the stop 128 from contact with the projection bar 160. The stop 128 precludes rotation in the opposite direction. The spring 170 is arranged below the housing 140 and has its back end hooked through an opening 172 in a spring mount 174 projecting from the housing bottom 146. The spring mount 174 is essentially stamped as an indentation in the metal of the housing 140.

The front end of the spring 170 is hooked through a hole 178 of an attachment member 176 which is welded to the push plate 120 directly beneath the stop 128. It is understood, however, that other methods may be used to attach the spring 170 to the housing 140 and the push plate 120.

The pedal assembly 180 pivots about an axle 192, which extends between the pedal mounts 148. The lever 184 actuates the drive segment 182.

Alternative dispositions of the spring 170 are possible. For example, it may be housed in a spiral fashion, with one end anchored at the axle 192 and the other end anchored to a point of the pedal assembly 180 spaced apart therefrom.

In the first embodiment, the drive segment 182 has teeth 190 which mesh with teeth 162 which project upwardly form the projection bar 160.

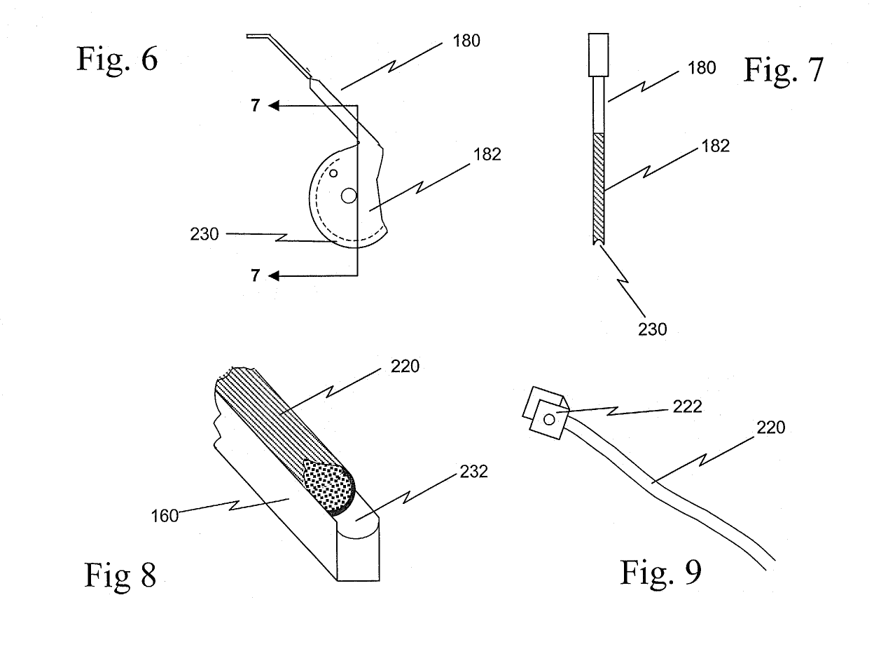

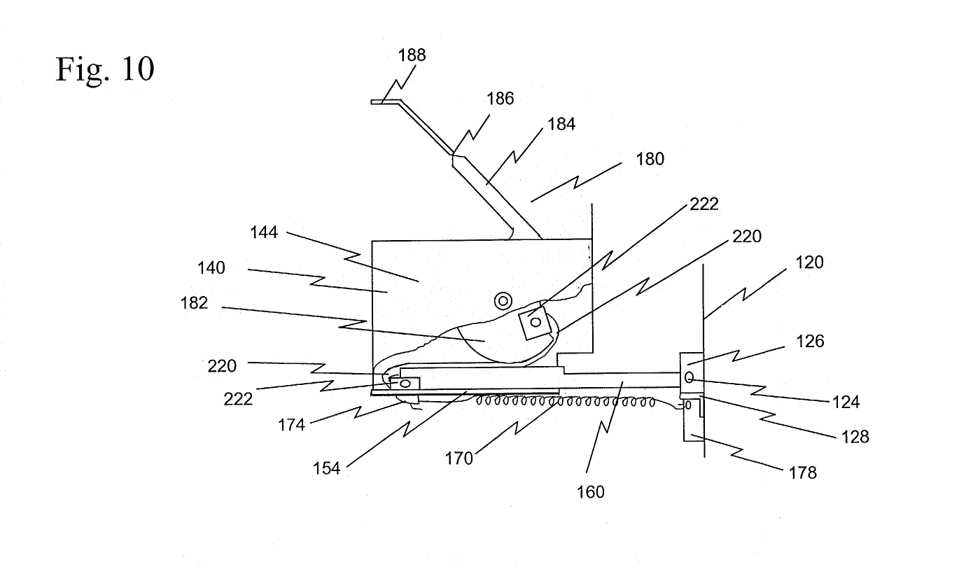

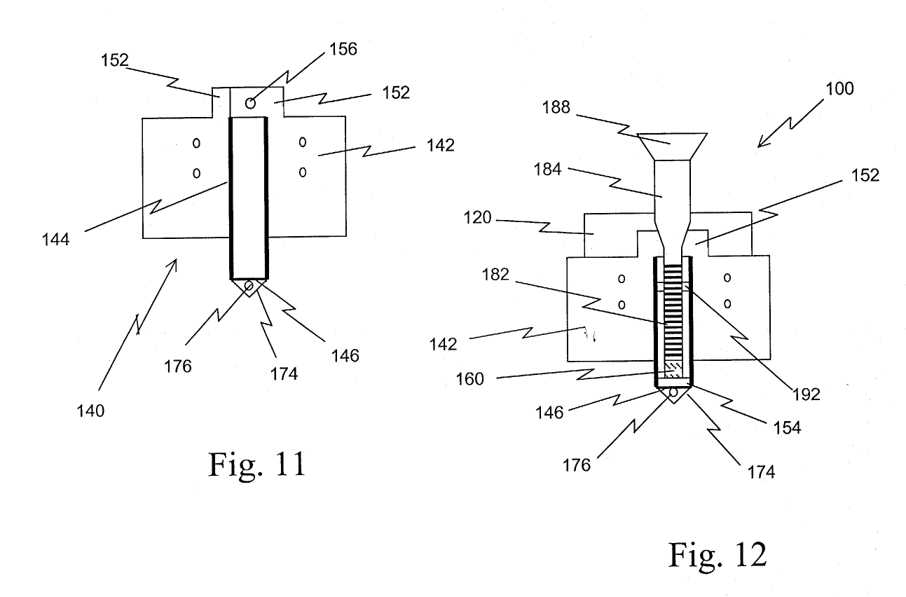

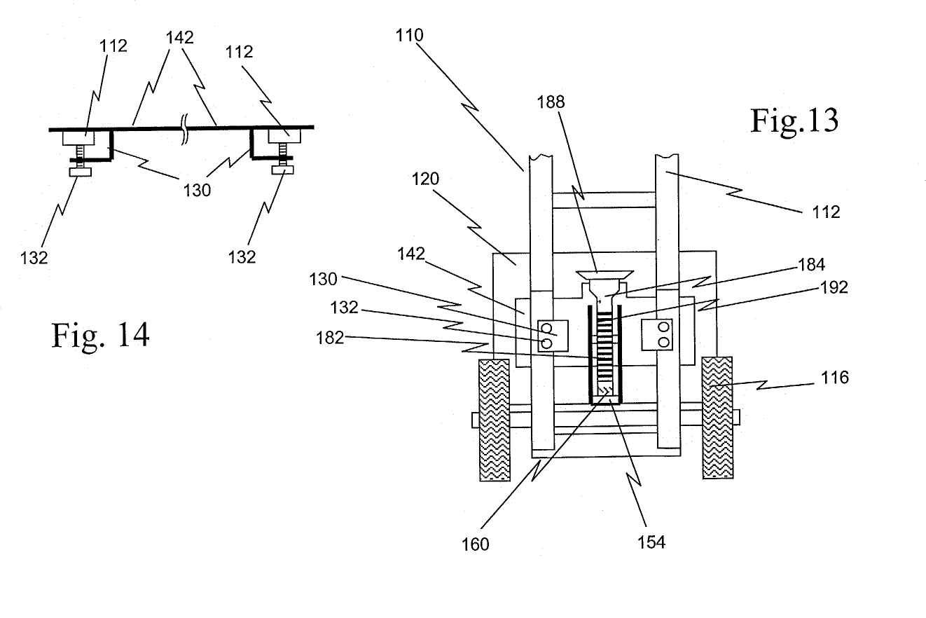

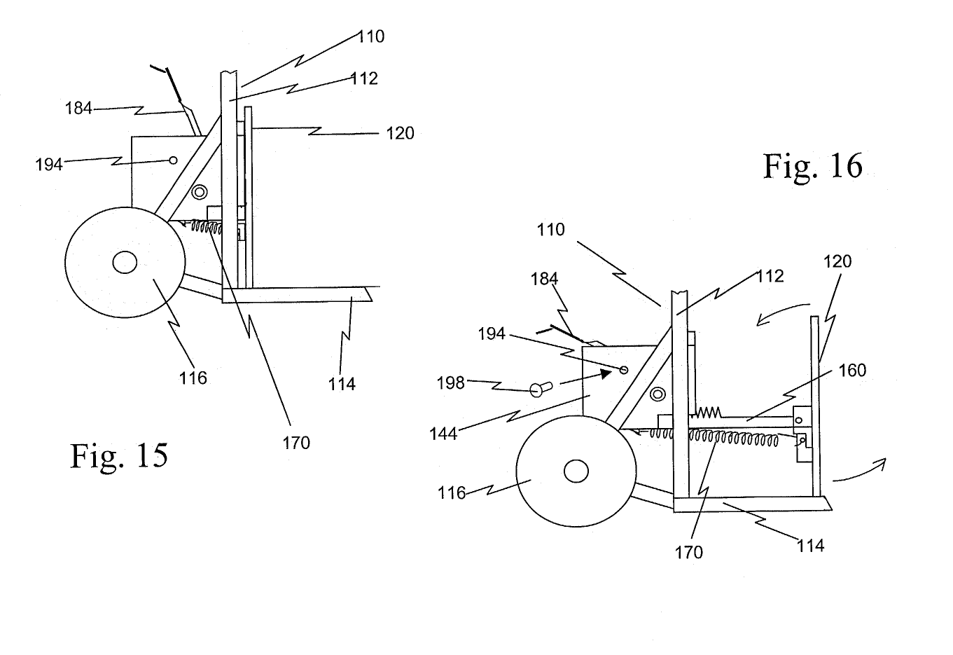

In the second embodiment, the drive segment 182 has a perimeter groove 230, which can receive the flexible cable 220, as indicated in FIGS. 6 and 7. The cable typically has multiple twisted individual strands of wire. The projection bar 160 has an upwardly facing groove 232 to receive the cable 220 as shown in FIG. 8. As indicated in FIGS. 9, the ends of the cable 220 are fixedly attached to cable brackets 222, for example by welding or crimping. One bracket 222 is attached to the drive segment 182 and the opposed bracket is attached to the projection bar 160. The brackets are attached for example by clamping or bolting to the appropriate member. Other methods may be used to attach the cable to the drive segment 182 or projection bar 160, for example by passing the cable through an opening and securing it by forming a securely closed loop. The cable is sized so that no significant slack is present when the push plate 120 is in the retracted position.

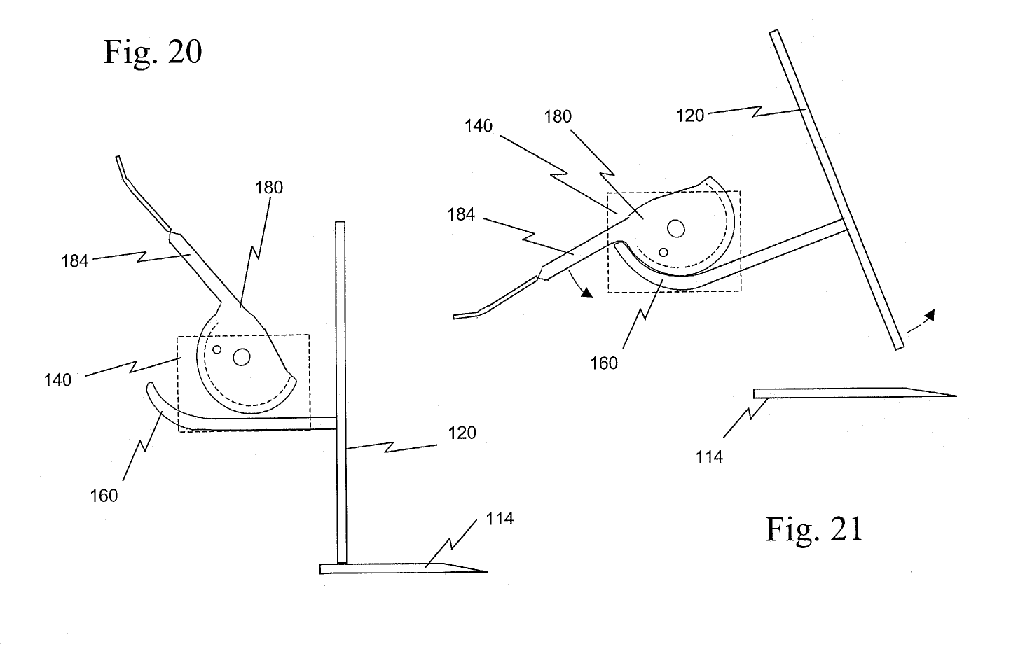

In the second embodiment, the projection bar 160 can be curved. In FIGS. 20 and 21 which show the projection bar 160 with upward curvature, essential elements of the assembly 100 such as the cable 220, and of the truck 110 such as the struts 112 are omitted for clarity. When the lever 184 is near its extended position, it contacts the upwardly curved portion of the projection bar 160 and pushes downward thereon. The curvature of the projection bar 160 permits it to tilt; in doing so, it can cause the push plate 120 to tilt in the manner of FIG. 21. This provides an additional forward component to the movement of the push plate 120, giving added impetus for unloading cargo from the hand truck 110.

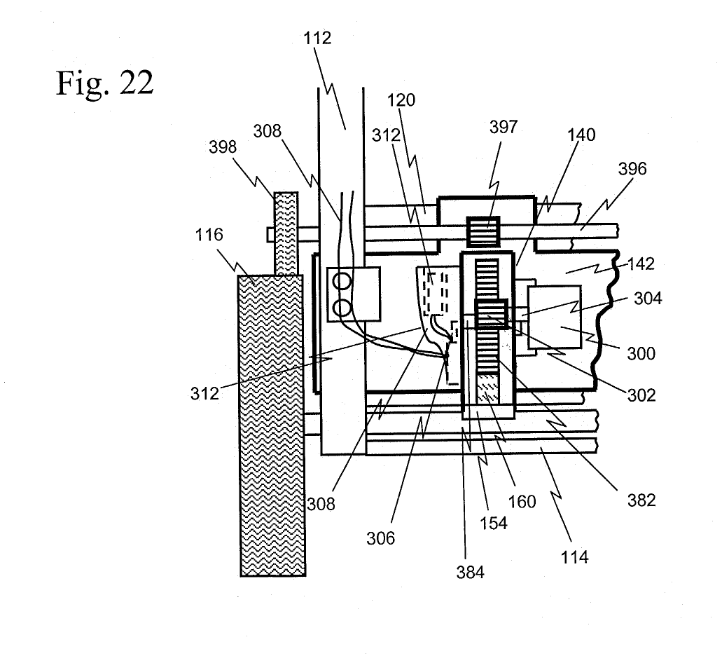

A third embodiment, illustrated in FIGS. 22-25, is electrically actuated. A gear wheel 382 has teeth 390 meshing with the teeth 162 of the projection bar 160. The gear wheel 382 is driven by a drive gear 302 mounted on a drive shaft 304 of an electric motor 300, which is attached to the housing 140 by suitable fasteners such as bolts. The gear wheel 382 is mounted on a shaft 384, which in turn is rotatably mounted in bearings 386 held in bearing apertures 388 of the housing 140.

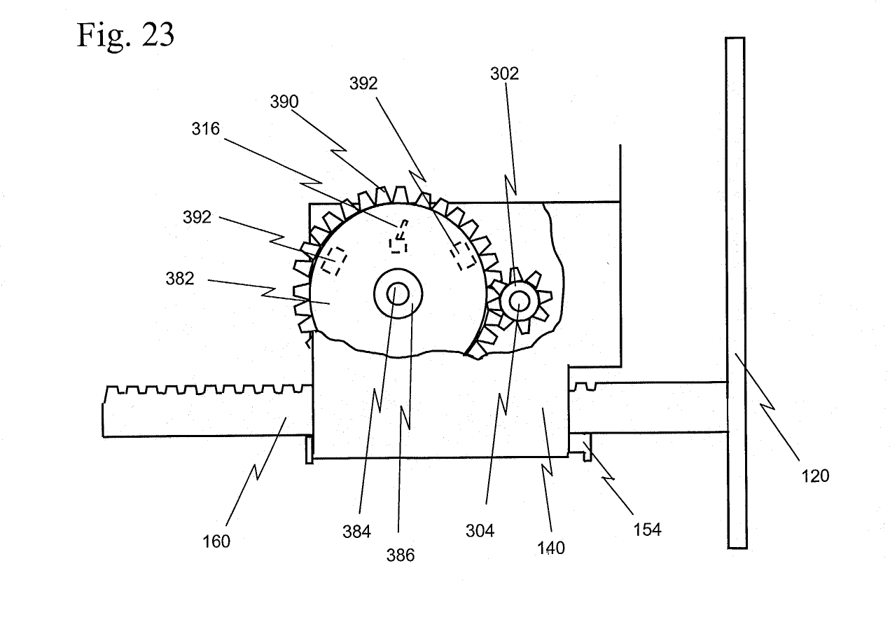

Preferably, the motor 300 is a 12V motor powered by a rechargeable battery 310, such as is used for power tools. The battery is removably held in a casing 312 attached to the housing 140. Preferably, the casing 312 is a single piece of molded plastic which can be any type of plastic commonly used in bodywork for appliances. The casing 312 can be affixed to the housing by any suitable fastening means such as bolts. Electrical control circuitry is provided on a circuit board 306, which has electrical conductors 308 connected to the battery 310, to the motor 300 (the motor connections are not shown), and to a control switch (not shown) which can be conveniently mounted for example on one of the struts 112. The circuitry and the control switch provide for the drive shaft 304 to be selectably rotated in either direction when the electric motor 300 is energized; thus the push plate 120 can be moved between the retracted and extended positions. As seen in FIG. 23, the push plate 120 is precluded from moving beyond either of its extreme positions by stops 392 affixed at predetermined positions on the gear wheel 382. The positions of the stops 392 are selected relative to a limit switch 316 that is fixedly attached inside the housing 140. The stops 392 move in an arc as the gear wheel 382 rotates. When the position of the gear wheel 382 corresponds to an extreme position of the push plate 120, the appropriate stop 392 actuates the limit switch 316 and de-energizes the electric motor 300, precluding further movement until the operator actuates the control switch to operate the electric motor 300 in reverse from its previous direction. Appropriate electrical circuitry being known, it will not be further described.

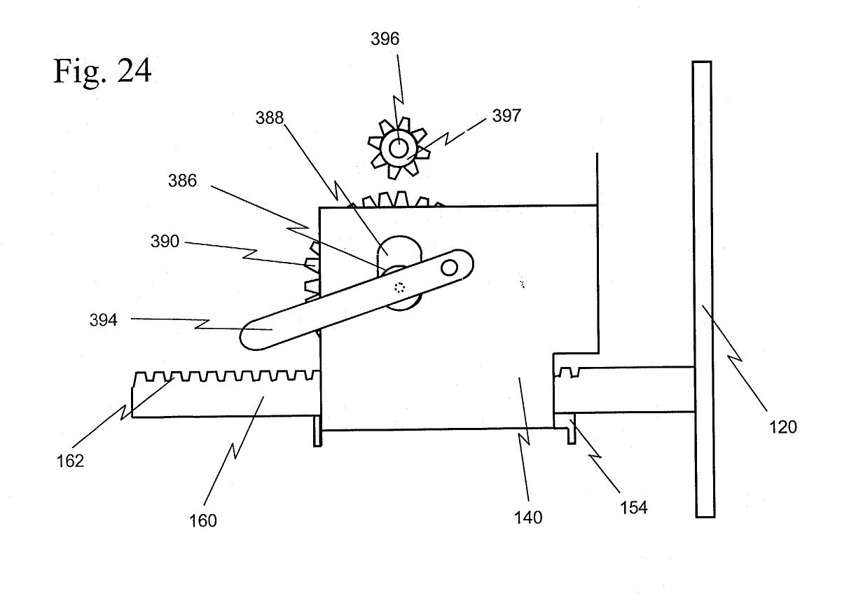

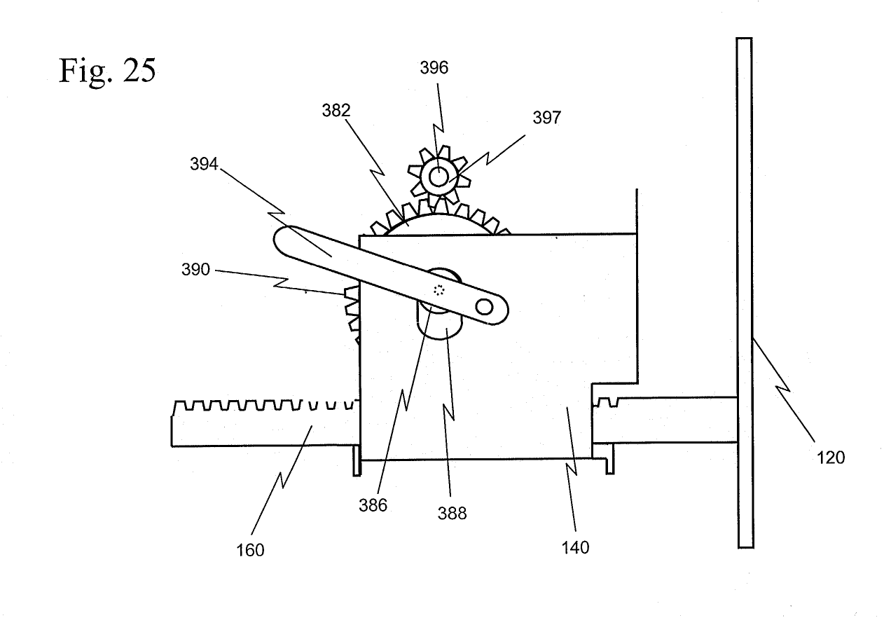

In addition to actuating the push plate 120, the electric motor 300 can optionally be used to provide powered assistance for moving the hand truck 110. As seen in FIGS. 24 and 25, the bearing apertures 388 are elongate, allowing the bearings 386 and the shaft 384 to be reversibly moved between lower and upper positions by means such as a lever 394, an end of which is pivotally attached to the housing 140, the lever 394 also pivotally engaging the shaft 384. The lever 394 has a locking mechanism (not shown) which can take various known forms to retain the shaft in the selected lower (push) or upper (drive) position. For example, the locking mechanism may include a spring loaded pin engaging either of two holes in the housing 140, depending on which position is selected.

When the bearings 386 are in the lower position, the gear wheel 382 engages the projection bar 160. When the bearings 386 are in the upper position, the gear wheel 382 is disengaged from the projection bar 160 and engages a propulsion gear 397 mounted on a propulsion shaft 396. Note that when thus raised, the gear wheel 382 nevertheless still engages the drive gear 302. The propulsion shaft 396 is transversely mounted in bearings (not shown) attached to the struts 112 by any suitable means. At the extremities of the propulsion shaft are propulsion wheels 398 that frictionally engage the wheels 116 of the hand truck 110. Both the hand truck wheels 116 and the propulsion wheels 398 are made of a material such as rubber conducive to good frictional contact, preferably with a suitable tread. Thus when the electric motor 300 is energized, it now assists the movement of the hand truck 110. The stops 392 are disposed in such a way that when the gear wheel 382 is in the upper position, the arc in which the stops 392 travel clears the limit switch 316. By contrast, when the gear wheel 382 is in the lower position, the arc intercepts the limit switch 316, the stops 392 thus defining the rotational limits of the gear wheel 382.

Optionally, the gear wheel 382 may be clutched in order to provide the operator with better control.

To summarize, then, the gear wheel 382 has selectable lower and upper positions for actuating the push plate 120 via the projection bar 160 and driving the handcart wheels 116 via the propulsion gear 397, respectively.

As previously indicated, the invention can be largely fabricated from sheet metal. This is especially desirable for the housing 140, which can be conveniently and inexpensively formed from a single flat piece. In the second embodiment especially, the pedal assembly can be conveniently and inexpensively molded from a hard plastic.

Although the push plate assembly 100 can be attached to the hand truck 110 in a variety of ways, such as bolting it directly thereto, it is preferably designed to be attached without in any way modifying the hand truck 110. An attachment bracket 130 is welded or otherwise affixed to each of the flanges 142. The brackets 130 are spaced apart and sized to be readily disposed adjacent the struts 112 in the manner shown in FIG. 14. Each attachment bracket 130 has at least one threaded hole (not shown) for accepting a bolt 132. Once the bolts 132 are tightened against the adjacent struts, the assembly 100 is secured to the hand truck 110. The invention is used in the following manner. A load such as a box or stack of boxes is loaded on the hand truck 110 in the usual way, with the push plate 120 in the retracted position. The load is essentially supported by the bottom chisel 114 and by the vertical spaced struts 112 of the hand truck 110. The load is then placed at a desired location such as against the wall of a transport truck. To release the load and retrieve the hand truck 110, the operator simply pushes downward on the lever 184. Through the drive segment 182 and rack 160, the push plate 120 is pushed forward against the load which is thus ejected from the chisel 114. If load is already against the wall or against other relatively immovable cargo, the action of the push plate 120 against the load impels the hand truck 110 to move back and leave the load behind.

When the hand truck 110 is withdrawn the operator releases the lever 184 and the return spring 170 pulls the push plate 120 back to its retracted position. This also moves the rack 160 rearward along the wear plate 154 and rotates the drive segment 182 so as to return the lever 184 to its inoperative (rest) position. During this movement, the push plate 120 is held upright by virtue of the L-shaped stop 128 between it and the bottom of the rack 160, this stop 128 being held by the helical tension spring 170.

For special service such as transporting an elongate carton 240, the drive segment 182 is provided with a hole 194 that comes into register with a pair of cross holes 196 in the sidewalls 144 when the treadle 184 is in its fully depressed position. In this position, these registering holes 194 and 196 are adapted to receive a locking pin 198, which secures the push plate 120 in its extended position.

When such a carton is to be transported, the lever 184 can be fully depressed by the operator so that the hole 194 in the drive segment 182 comes into register with the cross holes 196 in the sidewalls 144. The operator can then slip the locking pin 198 through these registering holes 194 and 196 so that the push plate 120 is fixed in its fully projected position. In this position, the hand truck frame can be placed in a lateral position with its handles or grips on the ground for loading the elongate carton loaded thereon. The carton is loaded so that one end is supported by the push plate 120, and the other end rests on the struts 112. The push plate 120 can tilt about the pin 124 against the opposition of the spring 170 to conform with the angle of the carton 240. The stop 128 is free to leave the bottom of the projection bar 160 for this purpose. The carton is transported with the hand truck inclined at a relatively small angle from the horizontal. The push plate 120 supports a relatively large area of the carton, instead of a carton wall having to rest on and possibly be damaged by the end of the chisel 114.

A differently shaped oversized carton 242, while not excessively long in a single direction, may be too bulky to be easily balanced on the chisel 114 while being loaded onto the hand truck 110; in this case, the push plate 120 can be rotated about the pin 124, against the opposition of the spring 170, in the direction indicated by the curved arrows in FIG. 16, to assume a position roughly parallel to the chisel 114. The spring 170 now tends to urge the push plate 120 as a whole toward the struts 112, but lacks sufficient moment about the pin 124 to restore the push plate 120 to its former position unassisted. The push plate 120 can now receive and support the oversize carton 242.

The electrically actuated embodiment is used in generally the same manner, except of course for energizing the electric motor 300 to move the push plate 120 in either direction. When the option of powered assistance for moving the hand truck 110 is available, the lever 394 is used to move the gear wheel 382 between the push and drive positions. Typically, the rechargeable battery 410 is removed from the casing 412 and charged at a charging station when the hand truck 110 is not in use. Normally, the charging station would be at a convenient location such as a loading dock where the hand truck 110 is normally used. On the hand, the hand truck 110 may be intended to accompany a delivery vehicle, in which case the charging station could be on board the vehicle.

The stamping of the major components of the push plate assembly 100 as single pieces is an advantage of the invention as it provides a manufacturing economy.

While the invention has been described with reference to preferred embodiments, it will be understood by those skilled in the art that various changes may be made and equivalents may be substituted for elements thereof without departing from the scope of the invention. In addition, many modifications may be made to adapt a particular situation of material to the teachings of the invention without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed:

1. A push plate assembly for a hand truck having a pair of spaced struts, a bottom chisel and wheels, the assembly comprising:
(a) a housing formed from a single piece of material, the housing having a pair of sidewalls, a base and a pair of contact flanges, the sidewalls having opposed bearing mounts and the flanges configured to contact the struts;
(b) a push plate having a bottom edge adjacent to the chisel, the push plate being movable between a retracted position and an extended position;
(c) a projection bar connected to the push plate and extending rearward from the push plate and sized to be received between the sidewalls; and
(d) an electrically driven impeller which engages the projection bar.

2. The push plate assembly of claim 1, wherein the projection bar has teeth and the impeller is a gear wheel having teeth which engage the teeth of the projection bar.

3. The push plate assembly of claim 2, the gear wheel being reversibly movable between a push position and a drive position.

4. The push plate assembly of claim 2, having a push position wherein the gear wheel and the projection bar are engaged and a drive position wherein the gear wheel is operably connected to the hand truck wheels.

5. The push plate assembly of claim 3, wherein the bearing mounts are elongate and the gear wheel is supported by bearings which are located in the bearing mounts and which are translatable therein.

6. The push plate assembly of claim 3, wherein a limit switch is disposed on the housing and the gear wheel has spaced apart stops which actuate the limit switch, the stops defining limits of rotation of the gear wheel.

7. The push plate assembly of claim 6, wherein the stops and the limit switch are disposed so that the stops only actuate the limit switch when the gear wheel is in the push position.

8. The push plate assembly of claim 2 wherein the gear wheel is clutched.

9. The push plate assembly of claim 2 wherein the gear wheel is driven by an electric motor attached to the housing.

10. The push plate assembly of claim 9 wherein the electric motor is energized by a battery.

11. The push plate assembly of claim 9 wherein the battery is removably mounted in a casing attached to the housing.

12. The push plate assembly of claim 9 wherein the battery is a rechargeable battery.
